(19) United States
(12) Patent Application Publication
(10) Pub. No.: US 2009/0276527 A1
(43) Pub. Date: Nov. 5, 2009

(54) Light Weight Process Abstraction For Distributed Systems

(76) Inventors: John Wesley Ferguson McClain, Lexington, MA (US); Robert William Scheifler, Somerville, MA (US); Peter C. Jones, Lexington, MA (US); Thomas Vinod Johnson, Lexington, MA (US)

Correspondence Address: BARRY W. CHAPIN, ESQ.;CHAPIN INTELLECTUAL PROPERTY LAW, LLC, WESTBOROUGH OFFICE PARK, 1700 WEST PARK DRIVE, SUITE 280, WESTBOROUGH, MA, 01581, US

(21) Appl. No.: 12/114,295

(22) Filed: May 2, 2008

(51) Int. Cl. G06F 15/173

(52) U.S. Cl. 709/226

(57) ABSTRACT

Methods and apparatus provide for a Process Descriptor to obtain an identity of an entity controlling resources of a plurality of computer systems linked via a network which access a common set of network file systems. Via a process abstraction, the Process Descriptor allows a user to describe a run-time configuration for a process to be run with the entity. The entity instantiates an instance for the process of the first application according to the first run-time configuration. For each process described by the process abstraction, the process' run-time configuration includes one or more unique network address associated with the process and network file systems, from the common set of network file systems, accessible by the process. By associating a unique network address with the process, communication with that process' instance is available wherever the instance is executing within the entity.

### BACKGROUND

Distributed computing is a method of computer processing in which different parts of an application run simultaneously on two or more computers that are communicating with each other over a network. Distributed computing requires that the division of the application take into account the different environments on which the different sections of the application will be running. As computational requirements of the application increase, the application can generally be partitioned into an increasing number of processes that can be placed on an increasing number of computers, thereby increasing the resources that can be brought to bear. If one of the computers crashes, then the processes that were placed on that computer can be restarted on another computer allowing the overall application to keep on functioning in the face of a failure occurring in one or more of the computers it is running on.

Distributed computing is a natural result of using networks to enable computers to communicate efficiently. There are numerous technologies and standards used to construct distributed computations, including some which are specially designed and optimized for that purpose, such as Remote Procedure Calls (RPC) or Remote Method Invocation (RMI) or .NET Remoting.

### SUMMARY

Conventional computer systems suffer from a variety of deficiencies. For example, in a conventional distributed system, complications arise with regard to (i) placing processes on computers within the conventional distributed application, (ii) keeping processes that happen to be placed on the same computer isolated from each other, (iii) restarting processes that were on a computer that failed, and (iv) making sure that a process has access to necessary resources while still allowing for communication with the process as it moves from computer to computer.

Techniques discussed herein significantly overcome the deficiencies of conventional applications such as those discussed above as well as additional techniques also known in the prior art. As will be discussed further, certain specific embodiments herein are directed to a Process Descriptor. The one or more embodiments of the Process Descriptor as described herein contrast with conventional systems to allow users (e.g. developers) to associate network addresses and files systems with processes so that communication between processes and file system access is not disrupted as the distributed system relocates processes executing within the distributed system.

For example, in one embodiment, a distributed system, connecting multiple computer systems via a network, can receive descriptions of processes from a process abstraction provided by the Process Descriptor. The process abstraction associates each process with one or more unique network addresses and indicates those file systems within the distributed system each process can access. Thus, the process abstraction describes the run-time environment for each process, but does not indicate characteristics with regard to an operating system or an actual location within the distributed system.

Based on the process abstraction, the distributed system creates an instance of each process according to a run-time configuration described in the process abstraction. The distributed system provisions resources from within the distributed system to create a run-time environment for each process instance. Each run-time environment is isolated from run-time environments corresponding to other process instances concurrently running in the distributed system.

As the workload of the distributed system fluctuates, the distributed system can relocate process instances to various locations within the distributed system to obtain an optimal use of resources with respect to its current workload. Since the Process Descriptor associates each process with one or more unique network addresses, process instances for a common application can communicate with each other via their respective unique network addresses regardless of their location within the distributed system or where the distributed system relocates processes.

In addition, since the Process Descriptor describes the files systems accessible by each process, the location of each process instance within the distributed system does not alter their interactions with the appropriate file systems. Thus, the Process Descriptor allows developers to easily describe the run-time environments of processes, while allowing the distributed system flexibility with regard to the location within the distributed system to actually execute process instances.

Specifically, the Process Descriptor obtains an identity of an entity (e.g. a distributed system) controlling resources of a plurality of computer systems, linked via a network, which access a common set of network file systems. Via a process abstraction, the Process Descriptor allows a user to describe a run-time configuration for a process to be run (i.e. executed) within the entity. The entity instantiates an instance for the process according to the run-time configuration.

For each process described by the user in the process abstraction, the process' run-time configuration includes one or more unique network address associated with the process and network file systems, from the common set of network file systems, accessible by the process. By associating a unique network address with the process, communication with that process' instance is available wherever the instance is executing within the entity.

Thus, the Process Descriptor allows the user (e.g. a developer) to use the process abstraction to break their application into a large number of fine-grained computations which can make it easier for a distributed system to efficiently utilize the available resources. Since the processes are fine-grained, they are considered light weight and have a high degree of isolation from other processes concurrently being executed within the distributed system. Thus, the user does not have be concerned with how two processes that happen to be executing on the same machine might interfere with each other. Further, independent of which computer in the distributed system the process runs on, its relationship to the network and file systems are the same, thereby simplifying development of the application.

In various embodiments, the processes can be considered lightweight because they do not require an entirely separate operating system instance in order to achieve isolation properties—such as an exclusive network addresses on the host, exclusive TCP & UDP port ranges, and separate local temporary file systems, etc. Typically, in conventional distributed applications, a comparable level of isolation on a single host computer requires hardware-level virtualization with a separate operating system per isolated entity. Such conventional isolation is considered heavyweight thereby requiring a longer start up and shut down and more consumption of resources on the host. In contrast, with the isolated processes being lightweight, a distributed application can make more fine-grained use of them—for example, it can feel more comfortable dividing its processing work into more separate (distributed) processes, because they have less overhead in time and resources.

Moreover, the process abstraction is lightweight because users need not specify what operating system to use or how the operating is configured. Yet, users are allowed to specify enough information (e.g. I.P. network addresses, file system mounts) such that the processes can be isolated from each other.

Other embodiments disclosed herein include any type of computerized device, workstation, handheld or laptop computer, or the like configured with software and/or circuitry (e.g., a processor) to process any or all of the method operations disclosed herein. In other words, a computerized device such as a computer or a data communications device or any type of processor that is programmed or configured to operate as explained herein is considered an embodiment disclosed herein.

Other embodiments disclosed herein include software programs to perform the steps and operations summarized above and disclosed in detail below. One such embodiment comprises a computer program product that has a computer-readable medium (e.g., tangible computer-readable medium) including computer program logic encoded thereon that, when performed in a computerized device having a coupling of a memory and a processor, programs the processor to perform the operations disclosed herein. Such arrangements are typically provided as software, code and/or other data (e.g., data structures) arranged or encoded on a computer readable medium such as an optical medium (e.g., CD-ROM), floppy or hard disk or other a medium such as firmware or microcode in one or more ROM or RAM or PROM chips or as an Application Specific Integrated Circuit (ASIC). The software or firmware or other such configurations can be installed onto a computerized device to cause the computerized device to perform the techniques explained as embodiments disclosed herein.

It is to be understood that the system disclosed herein may be embodied strictly as a software program, as software and hardware, or as hardware alone. The embodiments disclosed herein, may be employed in software and hardware such as those manufactured by Sun Microsystems Incorporated of Santa Clara, Calif., U.S.A.

Additionally, although each of the different features, techniques, configurations, etc. herein may be discussed in different places of this disclosure, it is intended that each of the concepts can be executed independently of each other or in combination with each other. Accordingly, the present invention can be embodied and viewed in many different ways.

Note also that this summary section herein does not specify every embodiment and/or incrementally novel aspect of the present disclosure or claimed invention. Instead, this summary only provides a preliminary discussion of different embodiments and corresponding points of novelty over conventional techniques. For additional details and/or possible perspectives (permutations) of the invention, the reader is directed to the Detailed Description section and corresponding figures of the present disclosure as further discussed below.

### BRIEF DESCRIPTION OF THE DRAWINGS

The foregoing and other objects, features and advantages of the invention will be apparent from the following more particular description of embodiments of the methods and apparatus for a Process Descriptor, as illustrated in the accompanying drawings and figures in which like reference characters refer to the same parts throughout the different views. The drawings are not necessarily to scale, with emphasis instead being placed upon illustrating the embodiments, principles and concepts of the methods and apparatus in accordance with the invention.

FIG. 1 is an example block diagram of process instances, running within a distributed system, configured according to run-time configurations provided by a Process Descriptor according to embodiments herein.

FIG. 2 is an example block diagram of process instances, running within a distributed system, communicating via unique network addresses and accessing file systems identified in run-time configurations provided in a process abstraction of a Process Descriptor according to embodiments herein.

FIG. 3 is an example block diagram of a process instance communicating via a unique network address and accessing a file system as support for the process instance is transitioned from one computer system of a distributed system to another computer system of the distributed system according to embodiments herein.

FIG. 4 is an example block diagram illustrating an architecture of a computer system that executes, runs, interprets, operates or otherwise performs a Process Descriptor application and/or a Process Descriptor process according to embodiments herein.

FIG. 5 is an example block diagram of multiple computerized systems, each executing a Process Descriptor, describing processes to be concurrently executed within a distributed system embodiments herein.

FIG. 6 is an example flowchart of processing steps performed by the Process Descriptor to provide a process abstraction to an entity according to embodiments herein.

FIG. 7 is an example flowchart of processing steps performed by the Process Descriptor to maintain communication with a process via unique network address as the process moves throughout an entity according to embodiments herein.

FIG. 8 is an example flowchart of processing steps performed by the Process Descriptor to maintain a process' access to a file system as the process moves throughout an entity according to embodiments herein.

### DETAILED DESCRIPTION

Methods and apparatus provide for a Process Descriptor to obtain an identity of an entity (e.g. a distributed system) controlling resources of a plurality of computer systems linked via a network which access a common set of network file systems. Via a process abstraction, the Process Descriptor allows a user to describe a run-time configuration for a process to be run within the entity. The entity instantiates an instance for the process of the first application according to the run-time configuration. For each process described by the process abstraction, the process' run-time configuration includes one or more unique network address associated with the process and network file systems, from the common set of network file systems, accessible by the process. By associating a unique network address with the process, communication with that process' instance is available wherever the instance is executing within the entity.

The distributed system (i.e. a plurality of computer systems linked via a network) receives the process abstraction, which describes the run-time configuration of the process. The run-time configuration identifies that process' unique network address and a network file system to which the first process has access.

Based on the run-time configuration described in the process abstraction, the distributed system provisions resources at a first computer system to create a run-time environment for an instance of the process. The distributed system creates the runtime environment such that it is isolated from interference from any other process instance running on the same computer system. Additionally, since the run-time environment is based on the run-time configuration described in the process abstraction, the instance of the process executing in the run-time configuration can access the network file system identified in the run-time configuration.

The distributed system allows for a second process of the same application to concurrently run on a second computer system in the distributed system. Instances of both processes can thereby communicate with each other by locating each other via their respective unique network addresses. Various examples of communication between processes running on the entity (i.e. grid) are: (1) a network protocol for a distributed memory cache system, (2) data flowing between processes that implement different processing nodes of a distributed workflow system, (3) communication of tasks and results in a distributed master/worker framework, (4) probes communicated by an agent process that is monitoring the health of other processes of the distributed application, (5) communication with parties outside the entity.

Based on the workload currently experienced by the distributed system, the distributed system determines that executing the instance of the process at another computer system would allow for an optimal use of resources within the distributed system. The distributed system provisions resources at a third computer system to create a new run-time environment for the instance of the process. The distributed system transitions support of the instance of the process from the first computer system to the third computer system. Although the instance of the process has been relocated to the third computer system, the instance of the process and the instance of the second process for the same application can continue to communicate with each other via their respective unique network address—which were each provided by the process abstraction. Further, as the instance of the process runs at the third computer system in the new run-time environment, the instance of the process still has access to the network file system identified in the run-time configuration.

It is understood that the Process Descriptor defines the run-time configuration for a single process which may execute many times in succession within the entity (e.g. distributed system). Further, in other embodiments, the Process Descriptor can specify the run-time configurations of multiple processes that are to be executed within the entity simultaneously. It is further noted that in various embodiment the Process Descriptor can be application code that causes one or more processes to be executed on the entity but the entity handles the provisioning of resources for the processed.

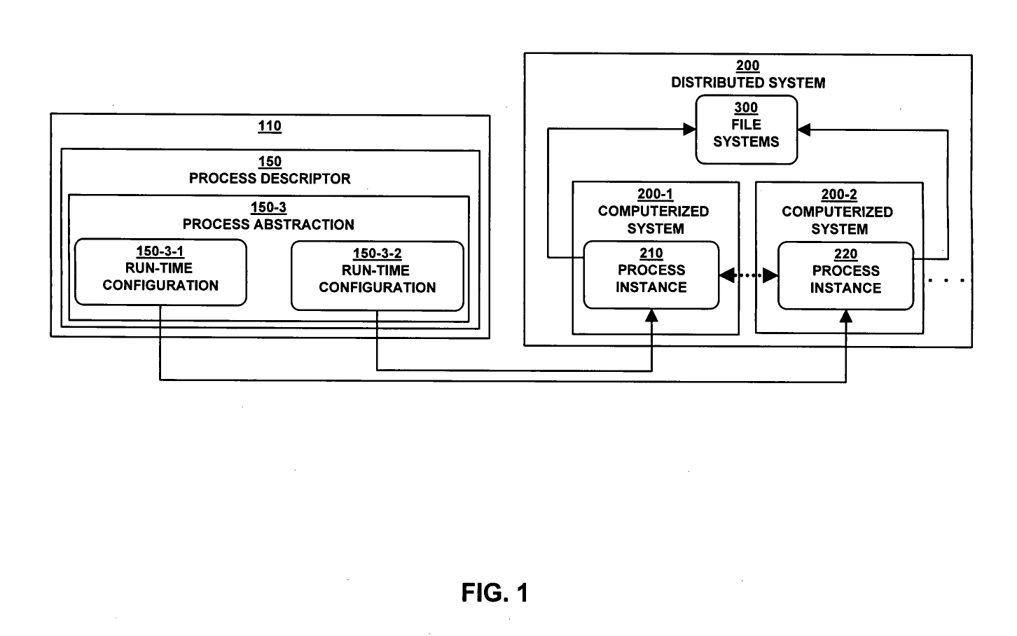

FIG. 1 illustrates an example block diagram of process instances 210, 220, running within a distributed system 200, configured according to run-time configurations provided by a Process Descriptor 150 according to embodiments herein.

The Process Descriptor 150 obtains an identity of a distributed system 200 (such as a distributed system) that controls resources 200-1-1, 200-1-2, 200-2-1 within a plurality of computer systems 200-1, 200-2, 200-3 linked via a network 190. In addition the plurality of computer systems 200-1, 200-2, 200-3 have access to a common set of network file systems 300. It is understood that the distributed system 200 is not limited to only three computer systems 200-1, 200-2, 200-3, as illustrated in FIGS. 1, 2 and 3.

The Process Descriptor 150 defines a process abstraction 150-3 to allow a user to describe run-time configurations 150-3-1, 150-3-2 for two processes of an application to be run within the distributed system 200. It is understood that the Process Descriptor 150 can provide a process abstraction 150-3 describing run-time configurations for any number of processes.

By providing the process abstractions 150-3 to the distributed system 200, the Process Descriptor 150 causes the distributed system 200 to instantiate an instance 210, 220 of both processes of the first application according to the run-time configurations 150-3-1 described in the process abstraction 150-3. Thus, the Process Descriptor 150 prompts the distributed system 200 to provision resources 200-1-1 within a computer system 200-1 for an instance 210 of a process according to the run-time configuration 150-3-1 described in the process abstraction 150-3. Additionally, the Process Descriptor 150 prompts the distributed system 200 to provision resources 200-2-1 within another computer system 200-2 for an instance 220 of a second process according to its respective run-time configuration 150-3-2 described in the process abstraction 150-3-2.

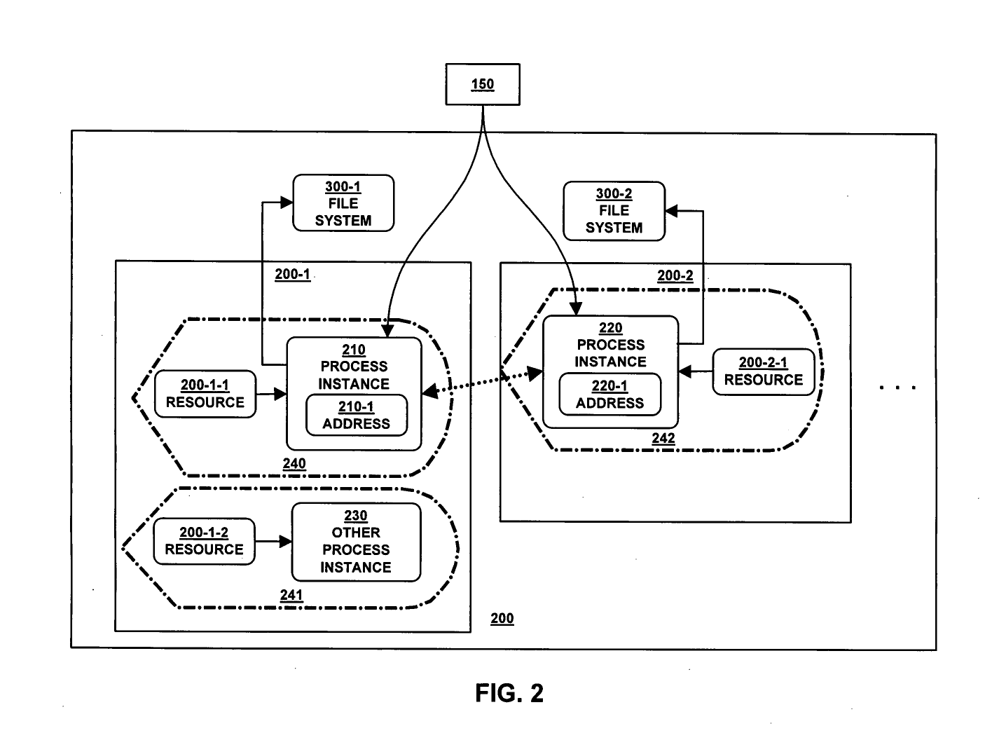

FIG. 2 is an example block diagram of process instances 210, 220, running within a distributed system 200, communicating via unique network addresses 210-1, 220-1 and accessing file systems 300-1, 300-2 identified in run-time configurations 150-3-1, 150-3-2 provided in a process abstraction 150-3 of a Process Descriptor 150 according to embodiments herein.

Upon prompting the distributed system 200 to provision resources 200-1-1, 200-1-2, 200-2-1, 200-3-1 by providing the process abstraction 150-3, the Process Descriptor 150 allows the distributed system 200 to allocate portions of hardware at a first computer system 200-1 to support a run-time environment 240 for the instance 210 of the first process. Additionally, the Process Descriptor 150 allows the distributed system 200 to allocate portions of hardware at a second computer system 200-2 to support a run-time environment 243 for the instance 220 of the second process. Further, the run-time configuration 150-3-1 described by the process abstraction 150-3 defines a run-time environment 240 for the instance 210 of the first process as isolated from any other run-time environment 241 for any other process 230 that concurrently executes within the same computer system 200-1.

The run-time configuration 150-3-1 described in the process abstraction 150-3 identifies a unique network address(es) 210-1 associated with the process instance 210 and a network file system(s) 300-1 that is accessible by the process instance 210. Similarly, the second run-time configuration 150-3-2 described in the process abstraction 150-3 identifies a unique network address(es) 220-1 associated with the second process instance 220 and a network file system(s) 300-2 that is accessible by the second process instance 220. By associating the unique network addresses 210-1, 220-1 with the two processes, the process instances 210, 220 are capable of communicating with each other—via the unique network addresses 210-1, 220-1—wherever they are executing in the distributed system 200.

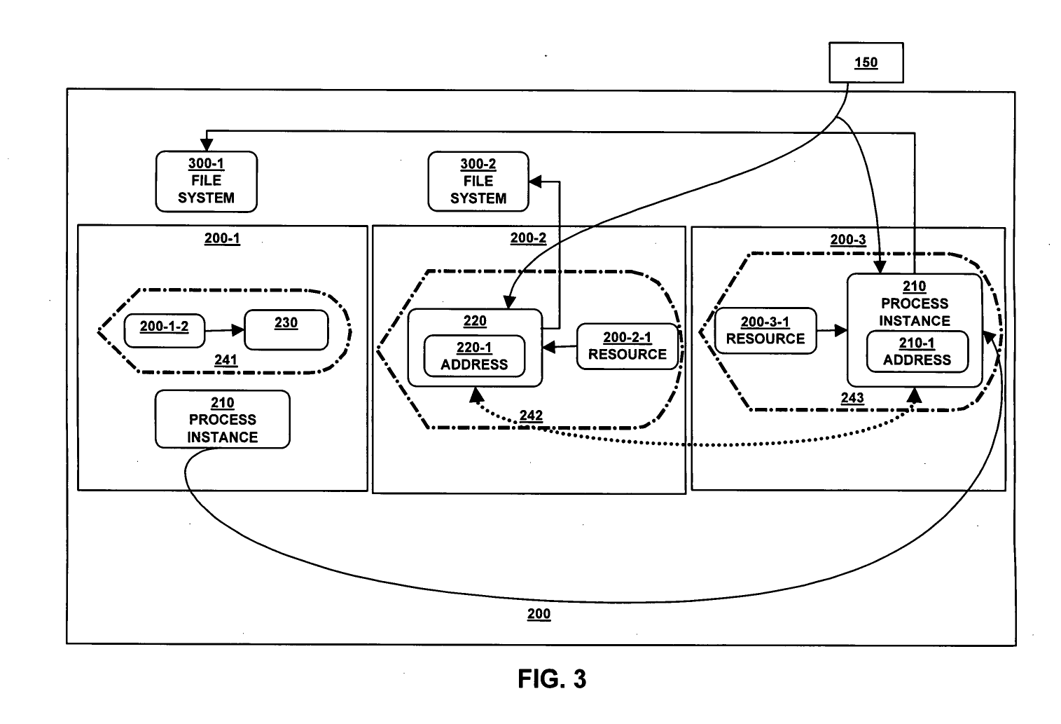

FIG. 3 is an example block diagram of a process instance communicating via a unique network address and accessing a file system as support for the process instance is transitioned from one computer system of a distributed system to another computer system of the distributed system according to embodiments herein.

Based on the current workload experienced by the distributed system 200, the distributed system 200 determines that the instance 210 of the first process running at a computer system 200-1 within the distributed system 200 should be supported at another computer system 200-3. Thus, the distributed system 200 transitions support of the instance 210 by provisioning resources 200-3-1 for execution of the instance 210 at another computer system 210-2. In another embodiment, such transition of the instance 210 of the first process can be initiated in response to the instance 210 of the first process crashing on the computer system 200-1.

The distributed system 200 thereby creates a new run-time environment 243 for the instance 210 of the first process at another computer system 200-3 in accordance with the run-time configuration 150-3-1 described in the process abstraction 150-3 (as shown in FIG. 1). Since the instance 210 of the first process is supported at another computer system 200-3 in accordance with the run-time configuration 150-3-1, communication with the instance 210 of the first process is maintained via the unique network address 210-1—regardless of where the instance 210 of the first process executes in the distributed system 200. Additionally, the instance 210 of the first process maintains access to the file system 300-1 identified in the process abstraction 150.

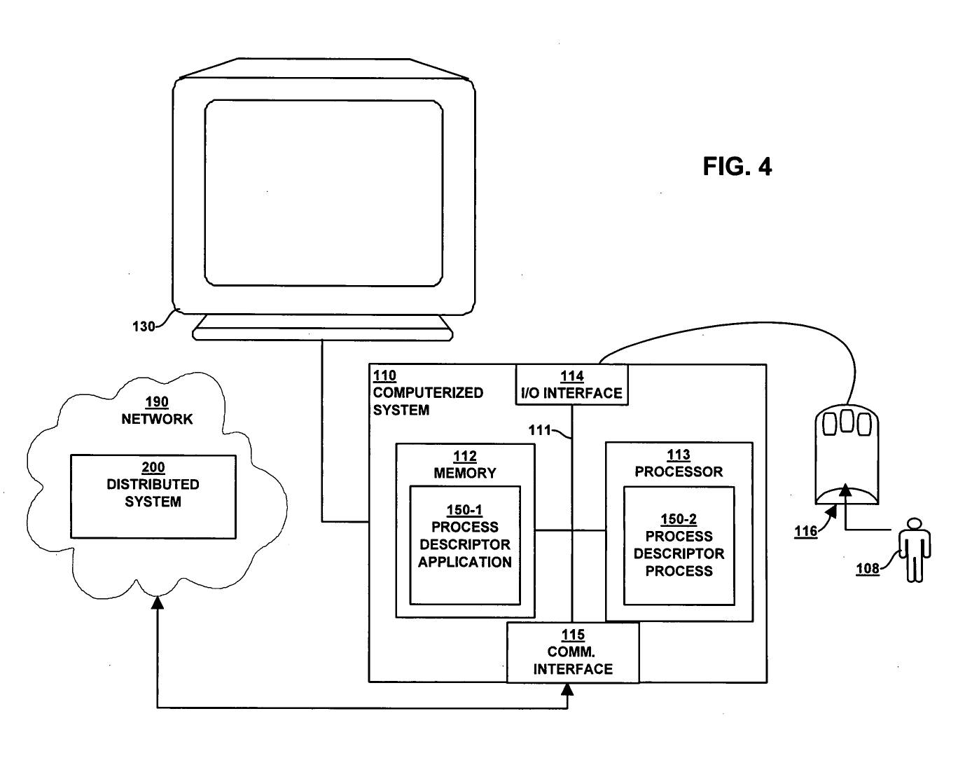

FIG. 4 is an example block diagram illustrating an architecture of a computer system 110 that executes, runs, interprets, operates or otherwise performs a Process Descriptor application 150-1 and/or Process Descriptor process 150-2 (e.g. an executing version of a Process Descriptor 150) according to embodiments herein.

Note that the computer system 110 may be any type of computerized device such as a personal computer, a client computer system, workstation, portable computing device, console, laptop, network terminal, etc. This list is not not exhaustive and is provided as an example of different possible embodiments.

In addition to a single computer embodiment, computer system 110 can include any number of computer systems in a network environment to carry the embodiments as described herein.

As shown in the present example, the computer system 110 includes an interconnection mechanism 111 such as a data bus, motherboard or other circuitry that couples a memory system 112, a processor 113, an input/output interface 114, and a display 130. If so configured, the display can be used to present a graphical user interface of the Process Descriptor 150 to user 108. An input device 116 (e.g., one or more user/developer controlled devices such as a keyboard, mouse, touch pad, etc.) couples to the computer system 110 and processor 113 through an input/output (I/O) interface 114. The computer system 110 can be a client system and/or a server system. As mentioned above, depending on the embodiment, the Process Descriptor application 150-1 and/or the Process Descriptor process 150-2 can be distributed and executed in multiple nodes in a computer network environment or performed locally on a single computer.

The Process Descriptor application 150-1 may be stored on a computer readable medium (such as a floppy disk), hard disk, electronic, magnetic, optical, or other computer readable medium. It is understood that embodiments and techniques discussed herein are well suited for other applications as well.

During operation of the computer system 110, the processor 113 accesses the memory system 112 via the interconnect 111 in order to launch, run, execute, interpret or otherwise perform the logic instructions of the Process Descriptor application 150-1. Execution of the Process Descriptor application 150-1 in this manner produces the Process Descriptor process 150-2. In other words, the Process Descriptor process 150-2 represents one or more portions or runtime instances of the Process Descriptor application 150-1 (or the entire application 150-1) performing or executing within or upon the processor 113 in the computerized device 110 at runtime.

Those skilled in the art will understand that the computer system 110 may include other processes and/or software and hardware components, such as an operating system. Display 130 need not be coupled directly to computer system 110. For example, the Process Descriptor application 150-1 can be executed on a remotely accessible computerized device via the communication interface 115. In addition, the communication interface 115 allows the Process Descriptor 150 to provide the process abstraction 150-3 to a distributed system 200 over a network 190.

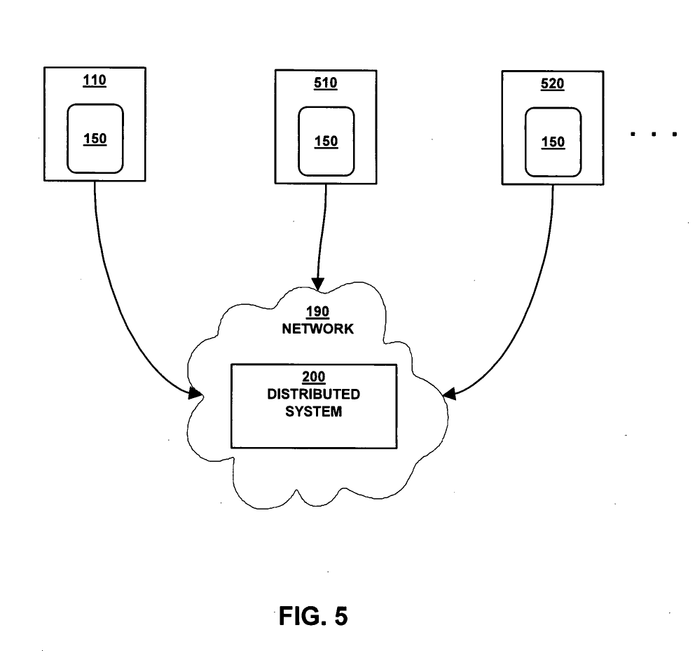

FIG. 5 is an example block diagram of multiple computerized systems 110, 510, 520, each executing a Process Descriptor 150, describing processes to be executed within a distributed system 200 embodiments herein.

As illustrated in FIG. 5, multiple computer systems 110, 510, 520 can each run their own instance of the Process Descriptor 150 to provide a process abstraction 150-3 to the distributed system 200. Thus, the distributed system 200 concurrently runs processes described in the process abstraction 150-3 of each instance of the Process Descriptor 150. Since the Process Descriptor 150 at each computer system 110, 510, 520 identifies one or more unique network addresses for each process and accessible file systems 300 for each process, the distributed system 200 can transition support of process instances to various locations in the distributed system 200 without disrupting process communication and process access to the file systems 300.

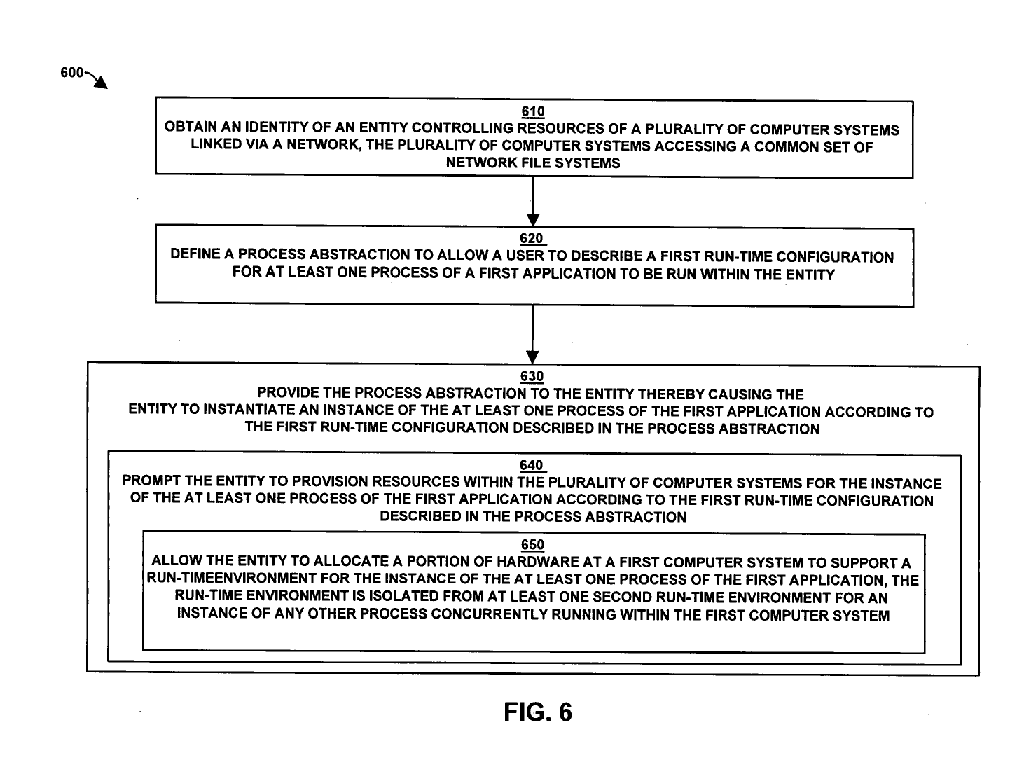

FIG. 6 through FIG. 8 illustrate various embodiments of the Process Descriptor 150. The rectangular elements in flowcharts 600, 700, and 800 denote “processing blocks” and represent computer software instructions or groups of instructions upon a computer readable medium. Additionally, the processing blocks represent steps performed by hardware such as a computer, digital signal processor circuit, application specific integrated circuit (ASIC), etc.

Flowcharts 600, 700, and 800 do not necessarily depict the syntax of any particular programming language. Rather, flowcharts 600, 700, and 800 illustrate the functional information one of ordinary skill in the art requires to fabricate circuits or to generate computer software to perform the processing required in accordance with the present invention.

It will be appreciated by those of ordinary skill in the art that unless otherwise indicated herein, the particular sequence of steps described is illustrative only and may be varied without departing from the spirit of the invention. Thus, unless otherwise stated, the steps described below are unordered, meaning that, when possible, the steps may be performed in any convenient or desirable order.

FIG. 6 is an example flowchart 600 of processing steps performed by the Process Descriptor 150 to provide a process abstraction 150-3 to an entity 200 according to embodiments herein.

At step 610, the Process Descriptor 150 obtains an identity of an entity (e.g. distributed system 200) controlling resources of a plurality of computer systems linked via a network. In addition, the distributed system provides the plurality of computer systems with access to a common set of network file systems.

At step 620, the Process Descriptor 150 defines a process abstraction to allow a user to describe a first run-time configuration for at least one process of a first application to be run within the entity.

At step 630, the Process Descriptor 150 provides the process abstraction to the entity, thereby causing the entity to instantiate an instance of the process of the first application according to the first run-time configuration described in the process abstraction.

At step 640, the Process Descriptor 150 prompts the entity to provision resources within the plurality of computer systems for the instance of the process of the first application according to the first run-time configuration described in the process abstraction.

At step 650, the Process Descriptor 150 allows the entity to allocate a portion of hardware at a first computer system to support a run-time environment for the instance of the process of the first application. The run-time environment is isolated from a run-time environment for an instance of any other process concurrently running within the first computer system.

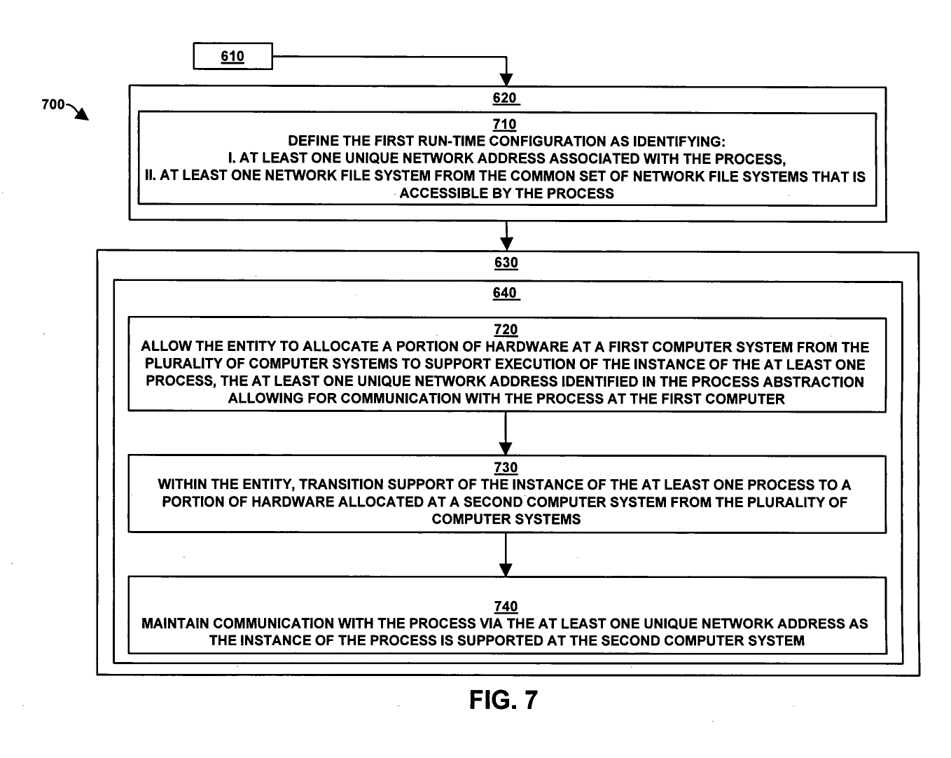

FIG. 7 is an example flowchart 700 of processing steps performed by the Process Descriptor 150 to maintain communication with a process via unique network address as the process moves throughout an entity according to embodiments herein.

At step 710, the Process Descriptor 150 defines the first run-time configuration as identifying a unique network address associated with the process and a network file system from the common set of network file systems that is accessible by the process. The Process Descriptor 150 associates the unique network address with the process such that the unique network address allows communication with the instance of the process while the instance executes within the entity.

At step 720, the Process Descriptor 150 allows the entity to allocate a portion of hardware at a first computer system to support execution of the instance of the process.

At step 730, support of the instance is transitioned to a portion of hardware allocated at another computer system.

At step 740, the Process Descriptor 150 maintains communication with the process via the unique network address as the instance of the process is supported at the other computer system. Thus, the instance of the process maintains communication with an instance of another process that is part of the same application via the unique network addresses.

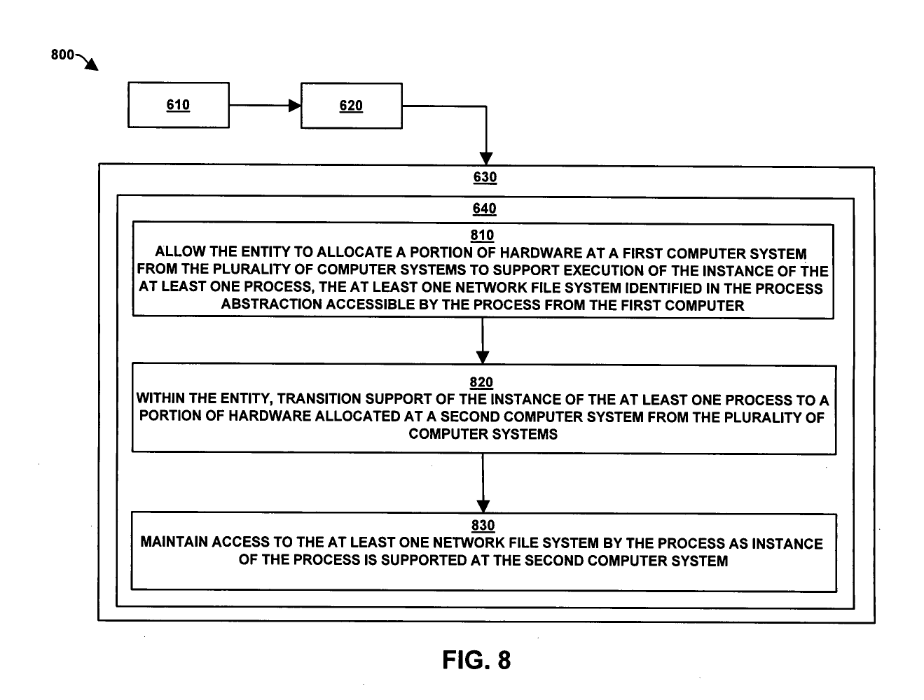

FIG. 8 is an example flowchart of processing steps performed by the Process Descriptor 150 to maintain a process' access to a file system as the process moves throughout an entity according to embodiments herein.

At step 810, the Process Descriptor 150 allows the entity to allocate a portion of hardware at a first computer system to support execution of the instance of the process. The instance of the process has access to a network file system identified in the process abstraction.

At step 820, support of the instance is transitioned to a portion of hardware allocated at another computer system.

At step 830, the Process Descriptor 150 maintains access to the network file system by the process as the instance of the process is supported at the other computer system.

Note again that techniques herein are well suited for a Process Descriptor 150 that allows a user to use via a process abstraction 150-3 to describe a run-time configuration 150-3-1 of a process 150-3 to be run within an entity 200.

The methods and systems described herein are not limited to a particular hardware or software configuration, and may find applicability in many computing or processing environments. The methods and systems may be implemented in hardware or software, or a combination of hardware and software. The methods and systems may be implemented in one or more computer programs, where a computer program may be understood to include one or more processor executable instructions. The computer program(s) may execute on one or more programmable processors, and may be stored on one or more storage medium readable by the processor (including volatile and non-volatile memory and/or storage elements), one or more input devices, and/or one or more output devices. The processor thus may access one or more input devices to obtain input data, and may access one or more output devices to communicate output data. The input and/or output devices may include one or more of the following: Random Access Memory (RAM), Redundant Array of Independent Disks (RAID), floppy drive, CD, DVD, magnetic disk, internal hard drive, external hard drive, memory stick, or other storage device capable of being accessed by a processor as provided herein, where such aforementioned examples are not exhaustive, and are for illustration and not limitation.

The computer program(s) may be implemented using one or more high level procedural or object-oriented programming languages to communicate with a computer system; however, the program(s) may be implemented in assembly or machine language, if desired. The language may be compiled or interpreted.

As provided herein, the processor(s) may thus be embedded in one or more devices that may be operated independently or together in a networked environment, where the network may include, for example, a Local Area Network (LAN), wide area network (WAN), and/or may include an intranet and/or the internet and/or another network. The network(s) may be wired or wireless or a combination thereof and may use one or more communications protocols to facilitate communications between the different processors. The processors may be configured for distributed processing and may utilize, in some embodiments, a client-server model as needed. Accordingly, the methods and systems may utilize multiple processors and/or processor devices, and the processor instructions may be divided amongst such single- or multiple-processor/devices.

The device(s) or computer systems that integrate with the processor(s) may include, for example, a personal computer(s), workstation(s) (e.g., Sun, HP), personal digital assistant(s) (PDA(s)), handheld device(s) such as cellular telephone(s), laptop(s), handheld computer(s), or another device(s) capable of being integrated with a processor(s) that may operate as provided herein. Accordingly, the devices provided herein are not exhaustive and are provided for illustration and not limitation.

References to “a processor”, or “the processor,” may be understood to include one or more microprocessors that may communicate in a stand-alone and/or a distributed environment(s), and may thus be configured to communicate via wired or wireless communications with other processors, where such one or more processor may be configured to operate on one or more processor-controlled devices that may be similar or different devices. Use of such “processor” terminology may thus also be understood to include a central processing unit, an arithmetic logic unit, an application-specific integrated circuit (IC), and/or a task engine, with such examples provided for illustration and not limitation.

Furthermore, references to memory, unless otherwise specified, may include one or more processor-readable and accessible memory elements and/or components that may be internal to the processor-controlled device, external to the processor-controlled device, and/or may be accessed via a wired or wireless network using a variety of communications protocols, and unless otherwise specified, may be arranged to include a combination of external and internal memory devices, where such memory may be contiguous and/or partitioned based on the application.

References to a network, unless provided otherwise, may include one or more intranets and/or the internet, as well as a virtual network. References herein to microprocessor instructions or microprocessor-executable instructions, in accordance with the above, may be understood to include programmable hardware.

Throughout the entirety of the present disclosure, use of the articles “a” or “an” to modify a noun may be understood to be used for convenience and to include one, or more than one of the modified noun, unless otherwise specifically stated.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

What is claimed is:

1. A method comprising:
obtaining an identity of an entity controlling resources of a plurality of computer systems linked via a network, the plurality of computer systems accessing a common set of network file systems;
defining a process abstraction to allow a user to describe a first run-time configuration for at least one process of a first application to be run within the entity; and
providing the process abstraction to the entity thereby causing the entity to instantiate an instance of the at least one process of the first application according to the first run-time configuration described in the process abstraction.

2. The method as in claim 1, wherein providing the process abstraction to the entity thereby causing the entity to instantiate an instance of the at least one process of the first application according to the first run-time configuration includes:
prompting the entity to provision resources within the plurality of computer systems for the instance of the at least one process of the first application according to the first run-time configuration described in the process abstraction.

3. The method as in claim 2, wherein prompting the entity to provision resources within the plurality of computer systems for the instance of the at least one process of the first application according to the first run-time configuration includes:
allowing the entity to allocate a portion of hardware at a first computer system to support a run-time environment for the instance of the at least one process of the first application, the run-time environment is isolated from at least one second run-time environment for an instance of any other process concurrently running within the first computer system.

4. The method as in claim 2, wherein defining the process abstraction includes:
defining the first run-time configuration as identifying:
i. at least one unique network address associated with the process; and
ii. at least one network file system from the common set of network file systems that is accessible by the process.

5. The method as in claim 4, wherein defining the first run-time configuration as identifying at least one unique network address associated with the process includes:
associating the at least one unique network address with the process such that the at least one unique network allows communication with the instance of the at least one process of the first application while the instance executes within the plurality of computer systems.

6. The method as in claim 4, wherein prompting the entity to provision resources within the plurality of computer systems for the instance of the at least one process of the first application according to the first run-time configuration includes:
allowing the entity to allocate a portion of hardware at a first computer system from the plurality of computer systems to support execution of the instance of the at least one process, the at least one unique network address identified in the process abstraction allowing for communication with the process at the first computer; and
within the entity, transitioning support of the instance of the at least one process to a portion of hardware allocated at a second computer system from the plurality of computer systems; and
maintaining communication with the process via the at least one unique network address as the instance of the process is supported at the second computer system.

7. The method as in claim 4, wherein prompting the entity to provision resources within the plurality of computer systems for the instance of the at least one process of the first application according to the first run-time configuration includes:
allowing the entity to allocate a portion of hardware at a first computer system from the plurality of computer systems to support execution of the instance of the at least one process, the at least one network file system identified in the process abstraction accessible by the process from the first computer; and
within the entity, transitioning support of the instance of the at least one process to a portion of hardware allocated at a second computer system from the plurality of computer systems; and
maintaining access to the at least one network file system by the process as instance of the process is supported at the second computer system.

8. The method as in claim 1, wherein defining the process abstraction to allow the user to describe the first run-time configuration for the at least one process of the first application includes:
allowing the user to describe the first run-time configuration for the at least one process independent of the user providing any operating system information required to run the at least one process within the entity.

9. The method as in claim 1, further comprising:
allowing a second user to utilize the process abstraction to describe a second run-time configuration for at least one process of a second application to be run within the entity; and
providing the process abstraction to the entity, the entity running the second application by instantiating an instance of the at least one process of the second application according to the second run-time configuration concurrently with the step of instantiating the instance of the at least one process of the first application.

10. The method as in claim 1, wherein defining the process abstraction includes defining the process abstraction in a class described by an object-oriented programming language.

11. A computer readable medium comprising executable instructions encoded thereon operable on a computerized device to perform processing comprising:
instructions for obtaining an identity of an entity controlling resources of a plurality of computer systems linked via a network, the plurality of computer systems accessing a common set of network file systems;
instructions for defining a process abstraction to allow a user to describe a first run-time configuration for at least one process of a first application to be run within the entity; and
instructions for providing the process abstraction to the entity thereby causing the entity to instantiate an instance of the at least one process of the first application according to the first run-time configuration described in the process abstraction.

12. The computer readable medium as in claim 11, wherein the instructions for providing the process abstraction to the entity thereby causing the entity to instantiate an instance of the at least one process of the first application according to the first run-time configuration include:
instructions for prompting the entity to provision resources within the plurality of computer systems for the instance of the at least one process of the first application according to the first run-time configuration described in the process abstraction.

13. The computer readable medium as in claim 12, wherein the instructions for prompting the entity to provision resources within the plurality of computer systems for the instance of the at least one process of the first application according to the first run-time configuration include:
instructions for allowing the entity to allocate a portion of hardware at a first computer system to support a run-time environment for the instance of the at least one process of the first application, the run-time environment is isolated from at least one second run-time environment for an instance of any other process concurrently running within the first computer system.

14. The computer readable medium as in claim 12, wherein the instructions for defining the process abstraction include:
instructions for defining the first run-time configuration as identifying:
i. at least one unique network address associated with the process; and
ii. at least one network file system from the common set of network file systems that is accessible by the process.

15. The computer readable medium as in claim 14, wherein the instructions for defining the first run-time configuration as identifying at least one unique network address associated with the process include:
instructions for associating the at least one unique network address with the process such that the at least one unique network allows communication with the instance of the at least one process of the first application while the instance executes within the plurality of computer systems.

16. The computer readable medium as in claim 14, wherein the instructions for prompting the entity to provision resources within the plurality of computer systems for the instance of the at least one process of the first application according to the first run-time configuration include:
instructions for allowing the entity to allocate a portion of hardware at a first computer system from the plurality of computer systems to support execution of the instance of the at least one process, the at least one unique network address identified in the process abstraction allowing for communication with the process at the first computer; and
instructions for transitioning support of the instance of the at least one process to a portion of hardware allocated at a second computer system from the plurality of computer systems; and
instructions for maintaining communication with the process via the at least one unique network address as the instance of the process is supported at the second computer system.

17. The computer readable medium as in claim 14, wherein the instructions for prompting the entity to provision resources within the plurality of computer systems for the instance of the at least one process of the first application according to the first run-time configuration include:
instructions for allowing the entity to allocate a portion of hardware at a first computer system from the plurality of computer systems to support execution of the instance of the at least one process, the at least one network file system identified in the process abstraction accessible by the process from the first computer; and
instructions for transitioning support of the instance of the at least one process to a portion of hardware allocated at a second computer system from the plurality of computer systems; and
instructions for maintaining access to the at least one network file system by the process as instance of the process is supported at the second computer system.

18. The computer readable medium as in claim 11, wherein the instructions for defining the process abstraction to allow the user to describe the first run-time configuration for the at least one process of the first application include:
instructions for allowing the user to describe the first run-time configuration for the at least one process independent of the user providing any operating system information required to run the at least one process within the entity.

19. The computer readable medium as in claim 11, comprising:
instructions for allowing a second user to utilize the process abstraction to describe a second run-time configuration for at least one process of a second application to be run within the entity; and
instructions for providing the process abstraction to the entity, the entity running the second application by instantiating an instance of the at least one process of the second application according to the second run-time configuration concurrently with the step of instantiating the instance of the at least one process of the first application.

20. A method comprising:
receiving a process abstraction at a distributed system, the process abstraction describing a first run-time configuration for a first process of a first application, the first run-time configuration identifying at least one unique network address associated with the first process and at least one network file system to which the first process has access, the distributed system comprising a plurality of computer systems linked via a network, a the plurality of computer systems accessing a common set of network file systems;
provisioning resources at a first computer system within the distributed system to create a run-time environment for an instance of the first process; and
maintaining communication between the instance of the first process of the first application at the first computer system and an instance of a second process of the first application at a second computer system via the at least one unique network address associated with the first process and at least one unique network address associated with the second process.

21. The method as in claim 20, wherein provisioning resources at a first computer system to create a run-time environment for the instance of the first process includes:
isolating the run-time environment within the first computer system from interference from any other process instance running on the first computer system as the instance of the first process executes at the first computer system.

22. The method as in claim 20, wherein maintaining communication between the instance of the first process of the first application and the instance of the second process of the first application at the second computer system includes:
provisioning resources at a third computer system to create a new run-time environment for the instance of the first process;
transitioning support of the instance of the first process from the first computer system to the third computer system; and
maintaining communication between the instance of the first process of the first application at the third computer system and the instance of a second process of the first application at the second computer system via the at least one unique network address associated with the first process and the at least one unique network address associated with the second process.

23. The method as in claim 20, comprising:
providing the instance of the first process access to the at least one network file system identified in the first run-time configuration as the instance of the first process runs at the first computer system;
provisioning resources at a third computer system to create a new run-time environment for the instance of the first process;
transitioning support of the instance of the first process from the first computer system to the third computer system; and
providing the instance of the first process access to the at least one network file system identified in the first run-time configuration as the instance of the first process runs at the third computer system.

24. A computer system comprising:
a processor;
a memory unit that stores instructions associated with an application executed by the processor; and
an interconnect coupling the processor and the memory unit, enabling the computer system to execute the application and perform operations of:
obtaining an identity of an entity controlling resources of a plurality of computer systems linked via a network, the plurality of computer systems accessing a common set of network file systems;
defining a process abstraction to allow a user to describe a first run-time configuration for at least one process of a first application to be run within the entity; and
providing the process abstraction to the entity thereby causing the entity to instantiate an instance of the at least one process of the first application according to the first run-time configuration described in the process abstraction.
